(19) United States
(12) Patent Application Publication
(10) Pub. No.: US 2014/0324705 A1
(43) Pub. Date: Oct. 30, 2014

(54) SYSTEM AND METHOD FOR EXCHANGING PHYSICAL MEDIA FOR A SECURED DIGITAL COPY

(71) Applicant: Andrew G. Setos, Pacific Palisades, CA (US)

(72) Inventor: Andrew G. Setos, Pacific Palisades, CA (US)

(73) Assignee: Fox Digital Enterprises, Inc., Los Angeles, CA (US)

(21) Appl. No.: 13/978,168

(22) PCT Filed: Jan. 5, 2012
(86) PCT No.: PCT/US12/20260

§ 371 Date: May 21, 2014

Related U.S. Application Data
(60) Provisional application No. 61/429,980, filed on Jan. 5, 2011.

(51) Int. Cl. G11B 20/00; G06F 21/60

(52) U.S. Cl. CPC G11B 20/00804; G06F 21/602
USPC 705/57; 705/325

(57) ABSTRACT

A system and method are provided for the exchange of physical media (e.g., legacy DVDs) for a secured digital copy that may be usable by a, consumer on one or more personal consumer devices, such as a laptop computer, handheld media player, etc., comprising receipt at a physical location of consumer-owned physical digital media, preparation of at least one secured digital media file corresponding to the received physical digital media, and delivery of the at least one secured digital media file to the consumer, the at least one secured digital media file configured to operate on one or more media playing devices of the consumer but to not be freely distributable.

### BACKGROUND

The present disclosure relates to a system and method for the exchange of physical media (e.g., legacy DVDs) for a secured digital copy that may be usable by a consumer on one or more personal consumer devices, such as a laptop computer, handheld media player, etc.

Consumers have limited options for transfer of media hard copies, such as legacy DVDs, into digital copies. Most processes involve cumbersome and complex software. Further, such software actually cracks the native encryption of the media file in order to create one or more encryption-free files. The problem with this approach (apart from potential legal concerns for software users breaking the native encryption) is that the file that is created may be freely distributed and freely viewed by multiple parties. Such free distribution of media devalues the media itself, as is well known by those that follow piracy trends in media distribution.

Further, the software processes noted above are typically time consuming. For example, for a standard DVD, with actual decryption and rendering of a DVD video quality file, such processes may take up to or more than an hour for each DVD, assuming that the rendering of the file is error free. Some processes may run, e.g., for 45 minutes, encounter an error and completely abort. In such cases, it may be frustrating for a user to even attempt to render a single DVD into a digital file usable by other devices, much less multiple DVDs. Further, where multiple formats are desired (e.g., for a DVD, a full native resolution file for a home media center and a reduced resolution file for a handheld media device), the process must be repeated for each physical media specifying the desired resolution.

What is needed in the art is a simple, secure mechanism for the exchange of a consumer's physical digital media for one or more secured digital media files, which mechanism alleviates the need for complicated and time-consuming consumer involvement.

### SUMMARY

The above-described and other problems and deficiencies of the prior art are overcome and alleviated by the presently described system and method for the exchange of physical media (e.g., legacy DVDs) for a secured digital copy that may be usable by a consumer on one or more personal consumer devices, such as a laptop computer, handheld media player, etc., comprising receipt at a physical location of consumer-owned physical digital media, preparation of at least one secured digital media file corresponding to the received physical digital media, and delivery of the at least one secured digital media file to the consumer, the at least one secured digital media file configured to operate on one or more media playing devices of the consumer but to not be freely distributable.

In exemplary embodiments, the at least one secured digital media file comprises a media file provided to the consumer using an encryption algorithm, e.g., AES) and a key message that is only consumable by a decryptor in the consumer's possession. In exemplary embodiments, the number of decryptors available to the consumer relative to the at least one secured digital media file may be variable from one to any desired number determined by the service provider.

Also, in exemplary embodiments, multiple secured digital media files may be delivered to the consumer in response to receipt of the physical digital media by the service provider. For example, a full, native resolution secured digital media file may be delivered alongside a lower resolution file, e.g., that may be more suitable for smaller or handheld devices. Also, one or more secure digital media files delivered to the consumer may include fewer features or functionality relative to the physical media. Lower resolution files and those files stripped of features or functionality provides for a smaller file, which smaller file may be desired for use on portable devices or mass storage devices intended to hold a large number of secured digital media files (e.g., network attached storage (“NAS”) devices or other media storage devices).

Further, one or more secure digital media files delivered to the consumer may include additional features or functionality relative to the physical media. Such media files may include higher resolutions or additional content, such as special features, links to Internet portals, etc.

Exemplery embodiments of the presently described system and method also provides a mechanism for additional revenue for media content providers and, where appropriate, host businesses. For example, additional revenue may be realized relative to the returned physical media when one or more media files provide additional content, higher resolution and/or the ability for the user to play the secured media file(s) on additional devices. Where a retail business, such as a software or media store, hosts physical media returns and provides or provides access to the secured media file(s), that business may also generates additional revenue from the transaction and from the customer draw relative to the service.

The above-discussed and other features and advantages of the presently described system and method will be appreciated and understood by those skilled in the art from the following detailed description and drawings.

### BRIEF DESCRIPTION OF THE DRAWINGS

Referring now to the drawings, wherein like elements are numbered alike in the following FIGURES:

FIG. 1 is a plan view of an exemplary system for improving measurement of viewing patterns by set meters and advertisement optimization; and

FIG. 2 is a flow chart illustrating an exemplary method for improving measurement of viewing patterns by set meters and advertisement optimization.

### DETAILED DESCRIPTION OF EXEMPLARY EMBODIMENTS

Reference will now be made in detail to exemplary embodiments, examples of which are illustrated by the accompanying drawing. As was noted above, the present disclosure relates to a system and method for the exchange of physical media (e.g., legacy DVDs) for a secured digital copy that may be usable by a consumer on one or more personal consumer devices, such as a laptop computer, handheld media player, etc., comprising receipt at a physical location of consumer-owned physical digital media, preparation of at least one secured digital media file corresponding to the received physical digital media, and delivery of the at least one secured digital media file to the consumer, the at least one secured digital media file configured to operate on one or more media playing devices of the consumer but to not be freely distributable.

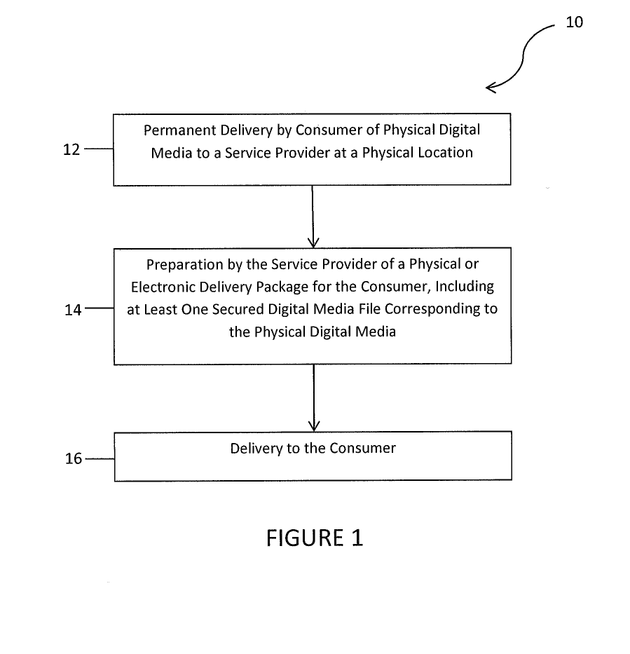

Referring now to FIG. 1, a flowchart illustrates generally at 10 an exemplary system and method in accordance with the above. At 12, a consumer permanently delivers physical digital media, such as a legacy DVD, to a physical service provider location. Such location could be a mailing address, a kiosk or the equivalent. In exemplary embodiments, such permanent delivery may comprise destruction of the physical media itself, erasure of the digital content, or the like, to ensure that the media is not further circulated in the marketplace.

At 14, the service provider prepares a delivery for the consumer, including a secured digital media file corresponding to at least some digital content stored on the physical digital media. Such package may be physical, e.g., comprising optical media on which the secured media file is stored, or the package may be electronic, such as an email containing the secured media file. At 16, the service provider delivers the package to the consumer.

In exemplary embodiments, preparation of the package and/or delivery of the package may be automatic, based upon receipt of the physical digital media and confirmation of the content of the physical digital media. Further, the at least one secured digital file may be generated from the digital media on the physical digital media, or the at least one secured digital file may be provided from another source, e.g., a storage device, available to the processing station. Additionally, a system may be provided with preset user preferences (e.g., file size or resolution preferences), such that the consumer will receive the desired type and size of secured digital file(s) in response to delivery of the physical digital media.

In exemplary embodiments, the at least one secured digital media file comprises a media file provided to the consumer using an encryption algorithm, e.g., AES) and a key message that is only consumable by a decryptor in the consumer's possession. In exemplary embodiments, the number of decryptors available to the consumer relative to the at least one secured digital media file may be variable from one to any desired number determined by the service provider.

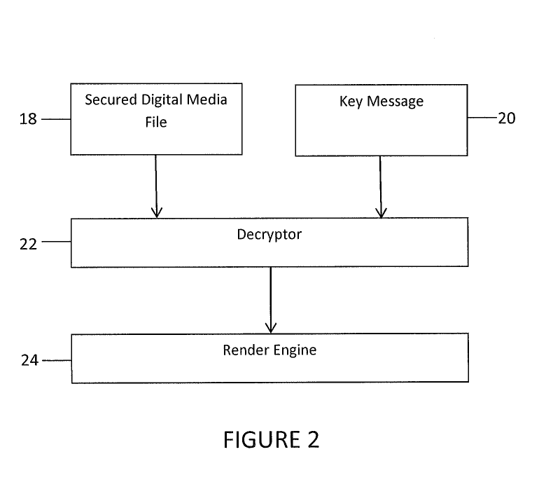

Reference is made to FIG. 2, which illustrates an example of such a system and method, wherein the consumer receives a secured digital media file 18 and a key message 20. A decryptor 22 enables playback by a render engine 24.

Also, in exemplary embodiments, multiple secured digital media files may be delivered to the consumer in response to receipt of the physical digital media by the service provider. For example, a full, native resolution secured digital media file may be delivered alongside a lower resolution file, e.g., that may be more suitable for smaller or handheld devices. Also, one or more secure digital media files delivered to the consumer may include fewer features or functionality relative to the physical media. Lower resolution files and those files stripped of features or functionality provides for a smaller file, which smaller file may be desired for use on portable devices or mass storage devices intended to hold a large number of secured digital media files (e.g., network attached storage (“NAS”) devices or other media storage devices).

Further, one or more secure digital media files delivered to the consumer may include additional features or functionality relative to the physical media. Such media files may include higher resolutions or additional content, such as special features, links to Internet portals, etc.

Exemplery embodiments of the presently described system and method also provides a mechanism for additional revenue for media content providers and, where appropriate, host businesses. For example, additional revenue may be realized relative to the returned physical media when one or more media files provide additional content, higher resolution and/or the ability for the user to play the secured media file(s) on additional devices. In an exemplary embodiment, the consumer may have choices such as selecting the number of devices that can play the secured media file(s) for varying charges, selecting the desired file format or resolution, designating specific devices or device types for playback (wherein the service can automatically select an appropriate format or resolution), selection of additional special features or other content related to the digital media on the returned physical media (which additional content may also affect the service price), etc.

In an exemplary embodiment, the system and method may provide a mail-in design, wherein a consumer may obtain (e.g., from a business or advertisement) or order a pre-paid envelope configured to facilitate the return of the physical digital media. In an alternative, directions may be provided for a consumer to package and mail the physical digital media.

In another exemplary embodiment, a business, e.g. a retail software or media store, provides customer service for return and processing of the physical digital media. In such embodiments, the business may provide the consumer with the secured digital media file(s) themselves, the business may provision the system such that it will physically or electronically deliver the secured digital media file(s) to the consumer, or the business may provide the consumer with access to the secured digital media file(s), e.g., by providing an access code or voucher that is validated by the system to provide the consumer with access to the file(s). In the latter case, a business side machine may contact a server indicating that the consumer is authorized (e.g., subsequent to payment, by provision of an authentication code, etc.) to receive the appropriate secured digital media file(s).

In another exemplary embodiment, a business, e.g. a retail software or media store, or other physical location hosts a kiosk for return and processing of the physical digital media. In such embodiments, the kiosk may provide the consumer with the secured digital media file(s) itself, the kiosk may provision the system such that it will physically or electronically deliver the secured digital media file(s) to the consumer, or the kiosk may provide the consumer with access to the secured digital media file(s), e.g., by providing an access code or voucher that is validated by the system to provide the consumer with access to the file(s). The kiosk may contact a server indicating that the consumer is authorized (e.g., subsequent to payment, by provision of an authentication code, etc.) to receive the appropriate secured digital media file(s).

Where a retail business, such as a software or media store, hosts physical media returns and provides or provides access to the secured media file(s), that business may also generates additional revenue from the transaction and from the customer draw relative to the service. For example, such a mechanism may then move a business that ordinarily deals only in physical stock into a new electronic media business.

In any embodiment, the system may also comprise a networked interface, such as via a kiosk or personal computer, over the Internet or otherwise, with a system server that provides consumer profile information or preferences, such as the desired type or format of files, designations of particular machines or machine types upon which the files will be played, selection of additional related content, or the like. Additionally, such interface may provide a consumer with selectable options relative thereto subsequent to permanent physical media return, such interface being available at a host business, kiosk or via a consumer's computer or another connected terminal.

Accordingly, the present disclosure presents a mechanism for the exchange of a consumer's physical digital media for one or more secured digital media files, which mechanism alleviates the need for complicated and time-consuming consumer involvement. Further, embodiments the presently described system and method generate new revenue relative to old physical media, both for the service and for a host business, where such host business exists. Host businesses benefit from increased customer traffic and from system service or other electronic retail revenues. Further, embodiments provide consumers with a mechanism whereby old physical media, which may otherwise be unused, may be securely exchanged for new media, e.g., with replacement of standard DVD resolution media with high definition or 3D resolution media or with secured media with additional or enhanced features, contents and links provided by the media content provider or via third parties. Additionally, embodiments of the system are configured to automatically or selectively provide appropriate secured media file(s) for specific machines or machine types appropriate for the individual consumer.

It will be apparent to those skilled in the art that, while exemplary embodiments have been shown and described, various modifications and variations can be made to the present system and method disclosed herein without departing from the spirit or scope of the invention. Accordingly, it is to be understood that the various embodiments have been described by way of illustration and not limitation.

What is claimed is:

1. A method for the exchange of physical media for a secured digital copy that may be usable by a consumer on one or more personal consumer devices, comprising:
receipt at a physical location of consumer-owned physical digital media;
preparation of at least one secured digital media file corresponding to the received physical digital media; and
delivery of the at least one secured digital media file to the consumer, the at least one secured digital media file configured to operate on one or more media playing devices of the consumer but to not be freely distributable.

2. A method in accordance with claim 1, wherein the at least one secured digital media file comprises a media file provided to the consumer using an encryption algorithm, and a key message that is only consumable by a decryptor in the consumer's possession.

3. A method in accordance with claim 1, wherein multiple secured digital media files are delivered to the consumer in response to receipt of the physical digital media by the service provider.

4. A method in accordance with claim 3, wherein said multiple secured digital media files include multiple copies of the same digital media at different compressions, resolutions or with different additional media features.

5. A method in accordance with claim 1, wherein said physical location comprises a mailing address or kiosk.

6. A system for the exchange of physical media for a secured digital copy that may be usable by a consumer on one or more personal consumer devices, comprising:
a physical location configured to receive delivered consumer-owned physical digital media;
a processing station configured to prepare a package of at least one secured digital media file corresponding to the received physical digital media; and
a delivery station configured to deliver the at least one secured digital media file to the consumer, the at least one secured digital media file configured to operate on one or more media playing devices of the consumer but to not be freely distributable.
